(19) United States
(12) Patent Application Publication
(10) Pub. No.: US 2010/0121128 A1
(43) Pub. Date: May 13, 2010

(54) Method and apparatus for thermochemical conversion of materials

(76) Inventors: Robert L. Hance, Austin, TX (US); John E. Kane, Houston, TX (US); Stephanie G. Dye, Houston, TX (US)

Correspondence Address: LOREN G. HELMREICH, 5851 San Felipe, SUITE 975, HOUSTON, TX, 77057, US

(21) Appl. No.: 11/407,770

(22) Filed: Apr. 19, 2006

(51) Int. Cl. A62D 3/38

(52) U.S. Cl. 588/320

(57) ABSTRACT

A system for treating carbon-containing or silicon-containing end-of-life material includes a reactor 10 for simultaneously supporting oxidation of the waste material and conversion of CO₂ within the reactor. A metal oxide or metal is input to the reactor to convert the CO₂ to a mineralized CO₂ product. A cold trap 44 is provided for capturing exhaust gases from the reactor and returning condensate to the reactor, and a pump 50 maintains a desired vacuum or pressure within the reactor and the cold trap.

### RIGHTS NOTICE

This invention was made with Government support under contract FA8651-04-C-0381 awarded by the Department of the Air Force, Air Force Research Laboratory. The Government has certain rights to the invention.

### FIELD OF THE INVENTION

The present invention relates to techniques for treating a carbon or silicon containing material with a chemical reaction, or series of chemical and physical reactions, to convert the material to a different form. More particularly, the invention relates to an efficient system for converting classified material to limit the ability to reverse engineer the material from the treatment residue.

### BACKGROUND OF THE INVENTION

There is a significant need in various industries to destroy classified, confidential end-of-life material in a manner that does not allow someone to reverse engineer the composition or properties of the material. Articles such as aircraft components, electronics or coating materials cannot be effectively destroyed in devices like shredders or pulverizers that are typically used to destroy classified data. Further, many of these articles contain hazardous substances such as heavy metals or volatile organic compounds. Processing an article containing hazardous substances would likely contaminate the device and subsequent lots of non-hazardous classified material.

Accordingly, hazardous materials or secret materials may be buried in quarantined landfills, or may be incinerated. The landfill solution is very expensive, and additional precautions must be taken to ensure that an unauthorized party does not gain access to the buried material. Incineration of the material is not only expensive, but also can produce undesirable emissions. In addition, incineration typically means that the material must be shipped considerable distances from one location to the location of an incinerator. During transport and processing the material must be quarantined and protected to prevent unauthorized parties from gaining access to the material before incineration. This level of protection adds substantially to the cost and complexity of destroying confidential or classified articles.

U.S. Publication 2003/0040651 discloses a system for chemically reducing waste materials, such as infectious waste materials and other hazardous, biohazards or reactive waste materials. More particularly, the system subjects the materials to a controlled alkaline hydrolysis cycle. The apparatus includes means for heating the interior of a vessel to a first predetermined temperature level after the introduction of water and an alkaline compound into the interior of the vessel for a duration sufficient to produce a safely disposable result.

U.S. Pat. No. 6,716,360 discloses another system for treating waste streams, and particularly waste sludge. The waste stream is input to the top of a downdraft column. The waste stream is conducted to the bottom of the column and conducts the waste stream to a first reaction zone. Nitrogen-containing oxides are introduced in the first reaction zone so that the waste stream is contacted with the nitrogen-containing oxides. The waste stream is conducted up the hydraulic updraft zone to a second reaction zone which is configured to provide sufficient time so that the reaction between the nitrogen-containing oxides and the waste solids may occur and consume the nitrogen-containing oxides.

U.S. Pat. No. 6,372,156 discloses a method of chemically converting raw material to another material utilizing a hybrid plasma system. The system utilizes a plasma including activated hydrogen and oxygen formed from a water vapor. U.S. Pat. No. 5,125,965 discloses a process for enhancing fluidization in a fluidized bed reaction chamber. In a preferred embodiment, the molybdenum oxide is reduced to a molybdenum metal. U.S. Pat. No. 4,368,169 discloses a pyrochemical process for the decomposition of water. The process is carried out in a reaction chamber of a reactor during and immediately after a thermonuclear reaction. The initial chamber reaction yields a condensed metal oxide product which is split in a later process to yield oxygen and a condensed metal product.

The disadvantages of the prior art are overcome by the present invention, and the included system is hereinafter disclosed for treating carbon-containing or silicon-containing fuel or waste material to convert the waste to a different form which prevents reverse engineering of the material.

### SUMMARY OF THE INVENTION

In one embodiment, the system for treating a carbon-containing or silicon-containing waste material comprises a reactor for supporting simultaneous oxidation of the material and conversion of CO₂ to a mineralized CO₂ product. A metal oxide or a metal is input into the reactor along with the material to be treated. The CO₂, a byproduct of the oxidation, is thus converted to a mineralized CO₂ product within the reactor. A cold trap is provided for capturing exhaust gas from the reactor and returning condensable vapors to the reactor. A pump maintains a desired pressure, which frequently is a vacuum, within the reactor.

According to one embodiment of a method according to the invention, a carbon-containing or silicon-containing material is treated by inputting the material into a reactor for supporting simultaneous oxidation of the material and conversion of CO₂ to a mineral powder or other mineralized CO₂ product. A selected metal oxide or metal is input into the reactor along with the material to be treated. Condensable gases from the reactor are condensed in a cold trap and the condensate returned to the reactor. A desired vacuum or pressure within the reactor is maintained with a vacuum pump.

These and further features and advantages of the present invention will become apparent from the following detailed description, wherein reference is made to the figures in the accompanying drawings.

### BRIEF DESCRIPTION OF THE DRAWINGS

FIG. 1 is a flow diagram of a suitable system for treating waste material.

FIG. 2 is a side view partial cutaway of a suitable fluid bed reactor.

### DETAILED DESCRIPTION OF PREFERRED EMBODIMENTS

The system of the present invention may be used to treat a carbon-containing or a silicon-containing waste material in a reactor which supports the simultaneous oxidation of the waste material and conversion of CO₂ to a mineral powder or other mineralized CO₂ product. The reactor utilizes a relatively low amount of energy, or may produce energy when the sum of the reactions are exothermic, and benefits from a significant reduction in capital and operating costs compared to reactors utilizing current technology.

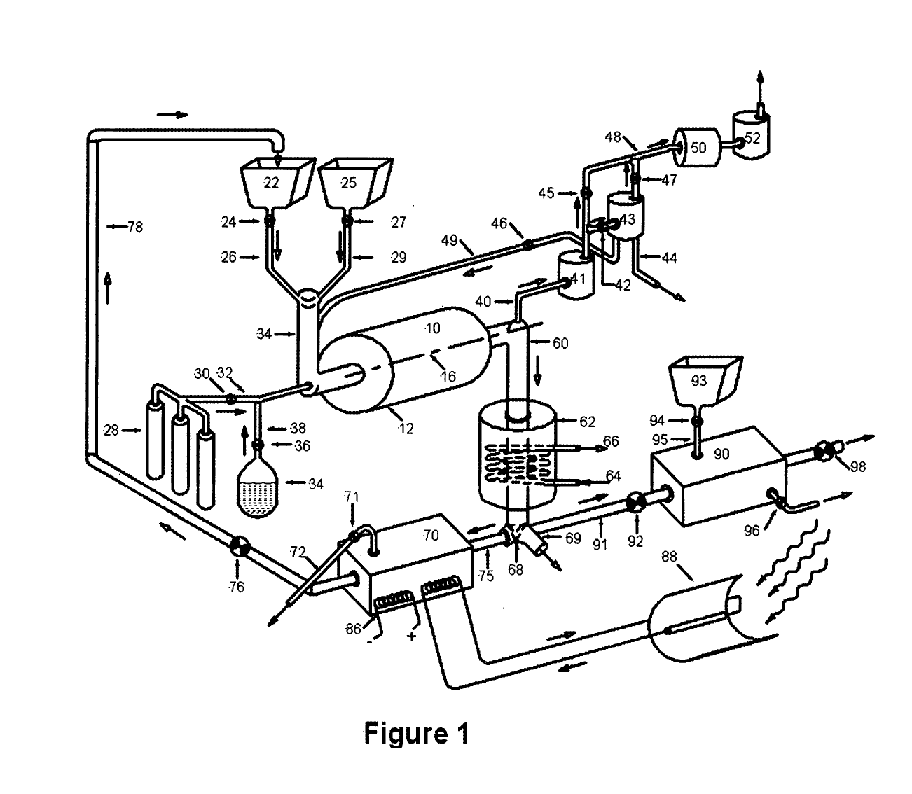

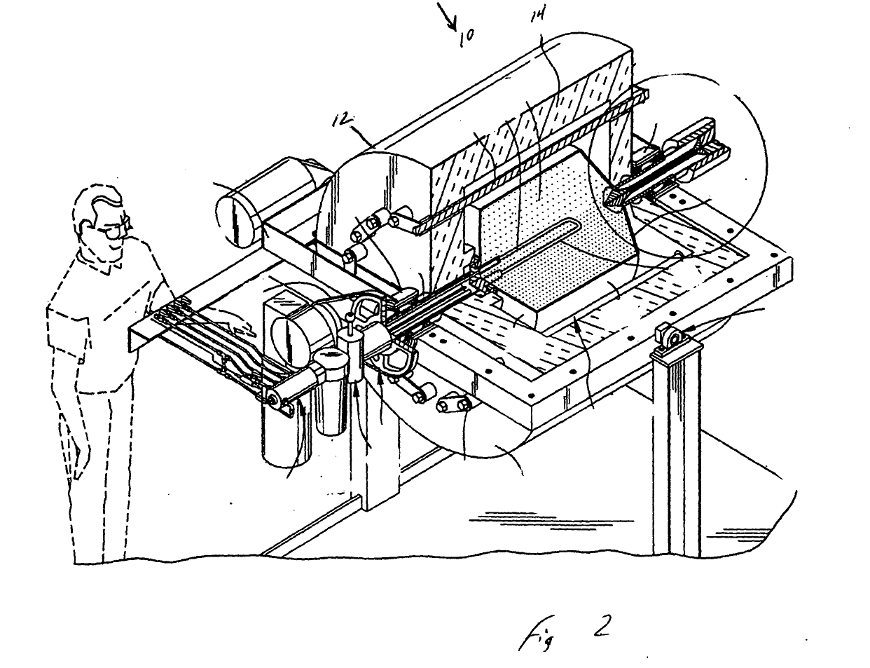

As shown in FIG. 1, the reactor 10 may be a fluid bed reactor which may reach its initial desired reactor temperature as a result of the input of conventional fuel and oxygen, or application of heat from a radiant energy source. As shown in FIG. 2, the bed of the reactor is a horizontal cylinder 12 with a chamber 14 therein, with the cylinder mounted to rotate about a substantially horizontal axis 16 of the reactor. One end of the reactor chamber may provide for the continuous or intermediate loading of the fuel or a fuel blend, and the reactive gas(es), while the opposite end of a reactor may have a mechanism for controllably discharging reaction products. Further details regarding a suitable reactor construction are disclosed in U.S. Pat. No. 6,379,610.

It should be appreciated that the reaction process and the conversion of CO₂ as discussed herein may occur in either a batch process or a continuous process. Those skilled in the art will appreciate that, for many applications, significant advantages of obtained by utilizing the methods discussed herein in a continuous process. The diameter of cylinder 12, the rotational speed of the cylinder 12, and the fill level within the chamber 14 are configured to fluidize the input material. The discharge reaction products from the reactor may be carbonate, silicate, alumino-silicate, and other materials which may be sold as recycled structural or chemical materials. The reactor preferably includes a reaction chamber having a volume of from 20 to 2,000 liters for a continuous reaction process.

The operation may be conducted by loading the cylinder, commencing rotation and initiating the reaction sequence. Once initiated, the reaction is preferably self-sustaining as long as a fuel blend and reactive gas(es) are fed into the cylinder. Exothermic reactions occur in sequence. In the first, carbon and oxygen combine to form CO₂, a byproduct of the oxidation. In the second, CO₂ combines with a mineral-forming element or compound, e.g., Ca, CaO or other metal or metal oxide, to form a mineralized CO₂ product or compound. In one application, the CO₂ reacts with a metal oxide such as calcium oxide, producing calcium carbonate. A metal or metal oxide for reacting with the CO₂ may be one or more from a group consisting of cadmium, manganese, lead, nickel, chromium, uranium, magnesium, beryllium and barium, or their respective oxides. The CO₂ produced in the first reaction is mostly or totally consumed in the second reaction, so that minimal exit gas is exhausted from the reactor. The system is also essentially “flameless,” and the reaction products are solid with the substantially higher heat-carrying capacity than gas.

The reactor of the present invention promotes complete combustion at relatively low operating temperatures, reducing production of SOₓ and NOₓ. In a conventional reactor system, if sulfur were present, sulfur compounds would be released and accelerate degradation of components in the burner zone, heat exchanger and exhaust system. In the present system, components of the fuel or fuel blend will preferentially react with nitrogen and any contained sulfur. Since the system fluidizes heated solids, heat transfers from a dense medium which reduces both system peak temperatures and heat exchanger volume.

The combination of lower system temperature and reduced volume of exhaust gas also provides benefits by reducing emissions of metals such as mercury and radionuclides. These metals may be present in trace or bulk amounts in some classified articles. In a conventional incineration system, they are incorporated in the exhaust gas stream and transported downwind, accumulating over time in nearby soils and bodies of water. The reactor of the present invention incorporates these materials in the mineral products, provides substantial surface area onto which these materials are adsorbed and/or reduces the transport of these materials from the reactor by minimizing the exhaust gas flow.

FIG. 1 illustrates a metal or metal oxide powder feeder 22 with a control valve 24 along flow line 26 for regulating the flow rate of metal or metal oxide to the reactor 10. Process gases from stored cylinders 28 or the atmosphere may flow through control valve 30 and line 32 to regulate the flow of process gases to the reactor 10, and optionally a CVD bubbler 34 may add vapor phase reactants to the reactor by flowing past control valve 36 in line 38. An atomizer or a direct liquid injection system may be used instead of a bubbler for adding vapor phase reactants to the reactor, which may serve to mask one or more of the metals in the reaction product.

Exhaust gases from the reactor may flow via line 40 to a dry filter 42, and then to cold trap or separation unit 44. Trap 44 captures vapors and returns condensate via line 46 to the reactor 10. Bypass valve 43 permits isolating the cold trap from the reactor, and control valves 45 restricts flow to and from the cold trap. Gas which passes by the cold trap 44 flows via line 48 to pump 50, which maintains the desired pressure (or vacuum) in both the reactor and the cold trap. The reactor temperature preferably is at least about 300° C. and less than about 900° C. Although the vacuum will vary with applications, in most cases the vacuum in the reactor is controlled to be at a level of about 100 to 760 Torr, and the vacuum in a cold trap is controlled to be from about 50 to 600 Torr. Gases discharged by the vacuum pump are passed to a conventional scrubber 52 and then passed to atmosphere. In other applications the pressure (or vacuum) within the reactor may be controlled to a level of from 0.1 to 2.0 atmospheres. The reactor chamber volume preferably is from about 20 liters to about 20,000 liters. If the desired pressure is below 1 atmosphere, the gas pump is conventionally referred to a vacuum pump. The term “pressure” as used herein means the absolute pressure of gas in the reactor, and may be a partial vacuum at less than one atmosphere.

In addition to having a lower operating cost compared to prior art systems, the system of the present invention has a significant advantage in being portable, thereby allowing the system to be economically transported to different sites for destruction of waste material.

A fluid bed reactor that rotates about a substantially horizontal axis is well suited for the system of the invention, since it allows a relatively high temperature to be controlled within the reactor, and reactive gases input to the reactor may also be controlled to regulate the environment of the materials within the reactor. While the system has been described for use with a fluid bed reactor, other types of reactors may be utilized which allow gases to come into contact with a high surface area of the material. Fluid bed reactors desirably provide for high mixing of the material to be treated within the reactor, and also regulate the input of the material to be treated and the reaction time, which are important to the process.

A separation unit other than a cold trap may be used for capturing exhaust gases and returning condensates to the reactor. Various types of gas absorber and filters, including those which are combustible and may be input back to the reactor when loaded with condensate materials, may be used for this separation process.

Various conventional technologies may be used for extracting valuable heat produced by the reaction discussed above. More specifically, the energy produced by the reaction may be used to provide heat for another process, including one for generating power using this heat.

The foregoing disclosure and description of the invention is illustrative and explanatory of preferred embodiments. It would be appreciated by those skilled in the art that various changes in the size, shape of materials, as well in the details of the illustrated construction or combination of features discussed herein maybe made without departing from the spirit of the invention, which is defined by the following claims.

1-14. (canceled)

15. A method for treating a carbon-containing waste material, comprising:
supporting simultaneous oxidation of the waste material and conversion to CO₂ in a reaction chamber of a reactor;
simultaneously with said oxidation and conversion, inputting a metal oxide or metal to the reaction chamber to convert the CO₂ to a mineral product;
capturing exhaust gases from the reaction chamber;
returning at least a portion of the captured exhaust gases to the reaction chamber; and
maintaining a desired pressure within the reaction chamber.

16. A method as defined in claim 15, further comprising:
inputting fuel to the reactor; and
inputting a reaction gas or vapor to the reactor.

17. A method as defined in claim 16, wherein the fuel and the reaction gases input to the reactor generate a reaction temperature of at least about 300° C. and less than about 900° C.

18. (canceled)

19. A method as defined in claim 15, wherein the reactor is a fluid bed reactor that rotates about a substantially horizontal reactor axis; and
the reactor has a reaction chamber volume of from 20 to 2,000 liters.

20. A method as defined in claim 15, wherein reaction of the CO₂ with the metal oxide or metal produces a mineral carbonate.

21. A method as defined in claim 15, wherein the metal or metal oxide includes a metal from a group consisting of calcium, magnesium, aluminum, sodium, cadmium, manganese, lead, nickel, chromium, uranium, magnesium, beryllium and barium.

22. A method as described in claim 15, wherein energy produced by the reaction is used to generate power or provide heat.

23. A method for treating a carbon-containing waste material, comprising:
supporting simultaneous oxidation of the waste material and conversion to CO₂ in a reaction chamber of a fluid bed reactor that rotates about a substantially horizontal axis;
simultaneously with said oxidation and conversion, inputting a metal oxide or metal to the reaction chamber to convert the CO₂ to a mineral product;
capturing exhaust gases from the reaction chamber; and
returning at least a portion of the captured exhaust gases to the reaction chamber; and
maintaining a desired pressure within the fluid bed reactor.

24. A method as defined in claim 23, further comprising:
inputting fuel to the fluid bed reactor; and
inputting a reaction gas or vapor to the reactor.

25. A method as defined in claim 23, wherein the fuel and the reaction gases input to the reactor generate a reaction temperature of at least about 300° C. and less than about 900° C.

26. A method as defined in claim 23, wherein reaction of the CO₂ with the metal oxide or metal produces a mineral carbonate.

27. A method as defined in claim 23, wherein the metal or metal oxide includes a metal from a group consisting of calcium, magnesium, aluminum, sodium, cadmium, manganese, lead, nickel, chromium, uranium, magnesium, beryllium and barium.

28. A method as described in claim 23, wherein energy produced by the reaction is used to generate power or provide heat.

29. A method for treating a carbon-containing waste material to generate power or provide heat, comprising:
supporting simultaneous oxidation of the waste material and conversion to CO₂ in a reaction chamber of a reactor;
simultaneously with said oxidation and conversion, inputting a metal oxide or metal to the reaction chamber to convert the CO₂ to a mineral carbonate;
inputting a reaction gas or vapor to the reaction chamber;
capturing exhaust gases from the reaction chamber and returning at least a portion of the exhaust gases to the reaction chamber; and
maintaining a desired pressure within the reaction chamber.

30. A method as defined in claim 29, wherein the fuel and the reaction gases input to the reactor generate a reaction temperature of at least about 300° C. and less than about 900° C.

31. A method as defined in claim 29, further comprising:
converting condensable vapors in the captured exhaust gases to a condensate, and returning at least some of the condensate to the reactor.

32. A method as defined in claim 29, wherein the reactor is a fluid bed reactor that rotates about a substantially horizontal reactor axis.

33. A method as defined in claim 29, wherein the metal or metal oxide includes a metal from a group consisting of calcium, magnesium, aluminum, sodium, cadmium, manganese, lead, nickel, chromium, uranium, magnesium, beryllium and barium.
